(19) United States
(12) Patent Application Publication
(10) Pub. No.: US 2010/0149336 A1
(43) Pub. Date: Jun. 17, 2010

(54) MICRO SUPERVISORY SYSTEM

(76) Inventors: Chiou-Liang Wang, Zhongli City (TW); Yen-Chen Chung, Longtan Shiang (TW); Chunn-Yenn Lin, Longtan Shiang (TW)

Correspondence Address: Dr. BANGER SHIA;Patent Office of Bang Shia, 102 Lindencrest Ct, Sugar Land, TX, 77479-5201, US

(21) Appl. No.: 12/333,242

(22) Filed: Dec. 11, 2008

(51) Int. Cl. H04N 7/18

(52) U.S. Cl. 348/158; 348/E07.085

(57) ABSTRACT

The micro supervisory system of the invention includes a casing, an image capture module, a display device, a gas generator, and a wireless transmission module. The image capture module is disposed in the casing, and captures an image and then generates an image signal. The display device receives the image signal and then generates a driving signal. The gas generator is disposed in the casing, and receives the driving signal and then generates a gas for anti-riot scenarios. The wireless transmission module receives and then transmits the image signal to the display device. Meanwhile, the wireless transmission module receives and then transmits the driving signal to the gas generator. Therefore, the tear gas can be released from the gas generator and is used for expelling people. The micro supervisory system of the invention can be applied to military spies, anti-riot supervision, and calamity supervision.

### BACKGROUND OF THE INVENTION

1. Field of the Invention

The invention relates to a supervisory system and particularly to a micro supervisory system for anti-riot. The micro supervisory system transmits a supervisory message via a wireless transmission interface and is applied to an anti-riot supervision and calamity supervision.

2. Description of the Prior Art

Nowadays, security demands such as home security and community security systems grow fast. A supervisory system can provide security and alarm functions and satisfies the security demand. The supervisory system has become more important nowadays.

There are many kinds of supervisory systems and devices applied in many applications. For example, WIPO patent No. 2004006204 discloses a spherical supervisory system capable of moving along a spherical track. The supervisory system includes a sensor providing functions of wireless transmitting and receiving and includes an infrared sensor. The supervisory system can be tossed, rolled, and rotated at all angles.

Additionally, U.S. patent No. 20050018044 discloses a portable supervisory device capable of wireless audio and video communication and provides a night-vision function. European patent No. 1096452 discloses a spherical supervisory device capable of being disposed on a wall or a ceiling.

Present supervisory systems transmit signals via a wireless or wired transmission interface. The supervisory system must be designed in consideration of volume limits, battery capacity, and environment, so present supervisory systems cannot and do not integrate functions of wireless transmission, releasing gas for anti-riot together.

Furthermore, in the aspect of volume, capsulate-size endoscope in the prior art has an optical system composed of LED and a lens. An image capture device and a wireless signal transmission device are configured to be modularity elements, so modularity elements can be manufactured to be integrated circuit (IC) elements via IC process. Therefore, elements of endoscope in the prior art can be encased in a capsulate-size casing. The capsulate-size endoscope in the prior art has an output power range from 0.010 mW to 0.032 mW, and the power intensity of the radio frequency (RF) signal ranges from −20 dBm to −15 dBm, so the effective receiving distance of the wireless signal only ranges from three to five meters. Therefore, the capsulate-size endoscope cannot satisfy the distance requirement (e.g. 200 m) of the present supervisory system.

Additionally, in the aspect of image capture, the image capture device in the prior art was composed of complementary metal oxide semiconductor (CMOS) and does not have an exposure gain adjustment function, so the image capture device in the prior art cannot adjust the brightness and compensate the image instantly.

Therefore, the invention provides a micro supervisory system to solve the aforementioned problems. The wireless transmission interface of the supervisory system of the invention has a longer effective transmission distance and a faster transmission speed. Additionally, the volume of the micro supervisory system of the invention is smaller. The micro supervisory system of the invention can accept instructions via wireless transmission and release tear gas to expel bad people such as gangsters and invaders, so the micro supervisory system of the invention can be applied to many applications such as military spies, anti-riot supervision, and calamity supervision.

### SUMMARY OF THE INVENTION

A main scope of the invention is to provide a micro supervisory system for anti-riot, and the micro supervisory system is capable of releasing tear gas to expel invaders. Therefore, the micro supervisory system can be applied to many applications such as military spies, anti-riot supervision, and calamity supervision.

The secondary scope of the invention is to provide a micro supervisory system for anti-riot, and the micro supervisory system includes a gas generator with a trunk casing. The gas generator receives an output signal from a wireless transmission module, and the output signal can trigger an igniter to be electrified, to cause an explosion inside the gas generator. Therefore, tear gas bursts through an aluminum alloy thin-film, and the gas generator releases large amounts of tear gas.

Another scope of the invention is to provide a micro supervisory system for anti-riot with a tumbler-shape casing. Therefore, no matter how the micro supervisory system of the invention are tossed, the micro supervisory system can be upright and keep capturing images at an angle of 45 degrees.

The micro supervisory system of the invention includes a casing, an image capture module, a display device, a gas generator, and a wireless transmission module. The image capture module is disposed in the casing, and captures an image and then generates an image signal. The display device receives the image signal and then generates a driving signal. The gas generator is disposed in the casing, and receives the driving signal and then generates a gas for anti-riot scenarios. The wireless transmission module receives and then transmits the image signal to the display device. Meanwhile, the wireless transmission module receives and then transmits the driving signal to the gas generator.

Furthermore, the casing of the supervisory system of the invention is designed to be a tumbler. Therefore, no matter how the supervisory system is tossed, the supervisory system can keep capturing image at an angle of 45 degrees.

The advantage and spirit of the invention may be understood by the following recitations together with the appended drawings.

### BRIEF DESCRIPTION OF THE APPENDED DRAWINGS

FIG. 1 is a block diagram illustrating a micro supervisory system according to a preferred embodiment of the invention.

FIG. 2 is a detail block diagram illustrating the micro supervisory system according to a preferred embodiment of the invention.

FIG. 3 is a schematic diagram illustrating the casing of the micro supervisory system according to a preferred embodiment of the invention.

FIG. 4 is a schematic diagram combining main elements of the micro supervisory system shown in FIG. 1 and the casing shown in FIG. 3.

FIG. 5 is a schematic diagram illustrating the gas generator according to a preferred embodiment of the invention.

### DETAILED DESCRIPTION OF THE INVENTION

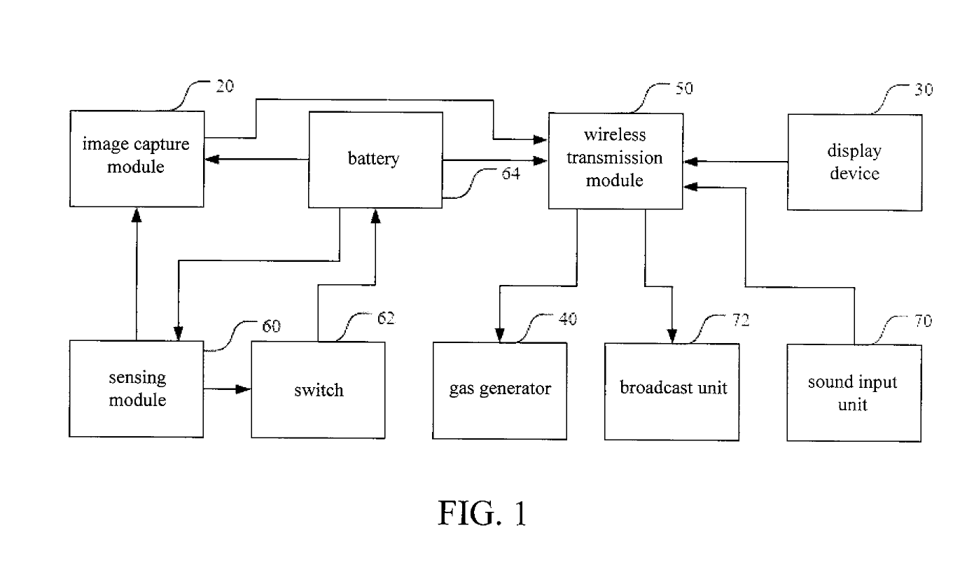

Please refer to FIG. 1. FIG. 1 is a block diagram illustrating a micro supervisory system 1 according to a preferred embodiment of the invention. The micro supervisory system 1 can be applied to military spies, anti-riot supervision, and calamity supervision, and includes a casing 10, an image capture module 20, a display device 30, a gas generator 40, and a wireless transmission module 50. The image capture module 20 and the gas generator 40 are disposed in the casing 10. The image capture module 20 captures an image to generate an image signal, and the display device receives the image signal and then generates a driving signal. In other words, the image captured by the image capture module 20 is displayed on the display device 30. When an abnormal situation is observed from the display device 30, the driving signal can be generated and transmitted to the gas generator 40. When the gas generator receives the driving signal, the gas generator releases a gas to expel people. The casing 10 and the display device 30 transmit signals to each other via the wireless transmission module 50. The wireless transmission module 50 receives and then transmits the image signal to the display device 30. The wireless transmission module 50 meanwhile receives and then transmits the driving signal to the gas generator 40. Then, the gas generator 40 is triggered by the driving signal to release a tear gas for anti-riot scenarios. Additionally, a material of the casing 10 is a shock-proof material, so when the user tosses the micro supervisory system of the invention, the micro supervisory system of the invention will not be damaged by the shock.

Furthermore, the micro supervisory system of the invention includes a sensing module 60, a switch 62, a sound input unit 70, and a broadcast unit 72. The sensing module 60 is disposed in the casing 10, and senses the presence of people to generate a sensing signal. When the switch 62 receives the sensing signal, the switch 62 switches a battery 64 on, and the battery 64 provides the image capture module 20 and the wireless transmission module 50 with power. Therefore, only when the sensing module 60 senses the presence of people is power provided to other devices, so the consumed power of the micro supervisory system can be reduced. Additionally, the sound input unit 70 can receive a sound to generate a sound signal, and the broadcast unit 72 receives the sound signal transmitted from the wireless transmission module 50 and then broadcasts the sound signal. Therefore, the sound input unit 70 and the broadcast unit 72 can be used for communication to achieve an anti-riot purpose.

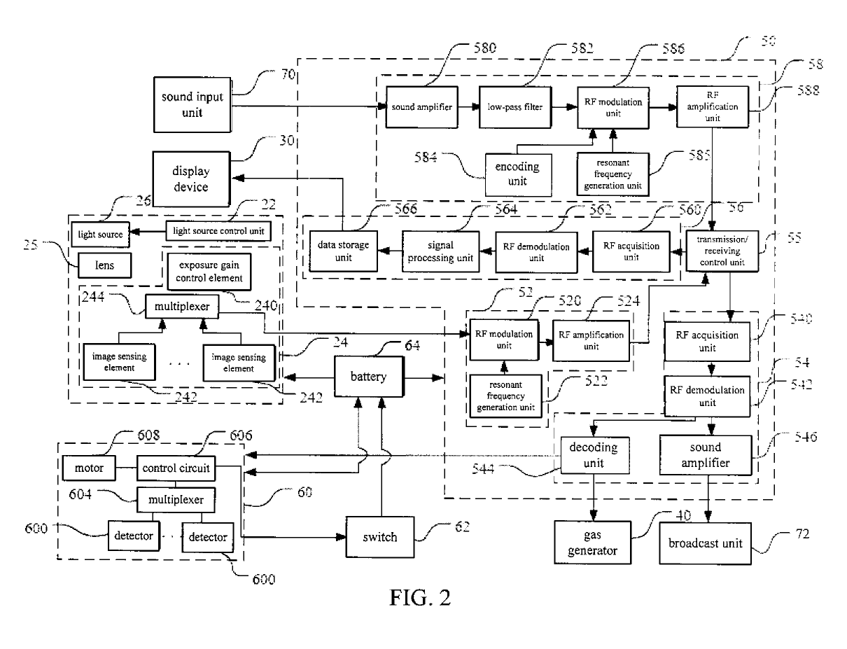

Please refer to FIG. 2. FIG. 2 is a detailed block diagram illustrating the micro supervisory system 1 according to a preferred embodiment of the invention. As shown in FIG. 2, the sensing module 60 includes at least one detector 600, a multiplexer 604, and a control circuit 606. The detector 600 can be disposed on and disposed around the casing 10. When the detector 600 detects the presence of people, the detector 600 generates a detection signal. The multiplexer 604 is coupled between the detector 600 and the control circuit 606, and is used for receiving the detection signal transmitted by the detector 600 and then generates the sensing signal to the switch 62. When the switch 62 receives the sensing signal, the switch 62 switches the battery 64 on.

The image capture module 20 includes a light source control unit 22 and an image sensing module 24. The light source control unit 22 receives the power and the sensing signal, and then adjusts the brightness of a light source 26 according to the environment brightness. The image sensing module 24 generates the image signal based on the image captured by a lens 25 and according to the brightness of the light source 26. Furthermore, the image sensing module 24 transmits the image signal to the wireless transmission module 50. The lens 25 is a non-spherical pantoscope with two lenses, or a liquid zoom lens. The image sensing module 24 includes an exposure gain control element 240, an image sensing element 242, and a multiplexer 244. The exposure gain control element 240 adjusts the light received by the lens 25 according to the environment brightness. The image sensing element 242 generates the image signal based on the image captured by the lens 25 and according to the light adjusted by the exposure gain control unit 240.

In this embodiment, the image sensing element 242 can be a CMOS sensing element for sensing image. The light source 26 can be a red-light LED or a white-light LED. When the supervisory system of the invention starts to operate, the light source control unit 22 will adjust the brightness of the light source 26 or switch the light source 26 on/off according to the environment brightness. The image sensing element 242 senses the image captured by the lens 26, and the exposure gain control element 240 adjusts the light received by the lens 25 according to the environment brightness. Therefore, the lens 25 can capture images under any brightness, and the image sensing element 242 can clearly sense the image and maintain the quality of the image signal.

The wireless transmission module 50 is disposed in the casing 10 and the display device 30 to achieve [instant supervisory. NOTE: Please check that 1 did not change the intended meaning] When the wireless transmission module 50 is disposed in the casing, the wireless transmission module 50 includes a wireless radiation circuit 52 and a wireless acquisition circuit 54. The wireless radiation circuit 52 receives and then transmits the image signal to the display device 30. The wireless acquisition circuit 54 receives the driving signal transmitted from the display device 30 and then transmits the driving signal to the gas generator 40. When the wireless transmission module 50 is disposed on the display device 30, the wireless transmission module 50 includes a wireless acquisition circuit 56 and a wireless radiation circuit 58. The wireless acquisition circuit 56 receives and then transmits the image signal to the display device 30. Furthermore, the display device 30 or the sound input unit 70 generates the driving signal. Then, the wireless radiation circuit 58 transmits the driving signal to the gas generator 40 or the broadcast unit 72.

The wireless radiation circuit 52 includes a RF modulation unit 520, a resonant frequency generation unit 522, and a RF amplification unit 524. The RF modulation unit 520 modulates the image signal, and transmits the image signal to the RF amplification unit 524 according to the frequency of the resonant frequency generation unit 522. The RF amplification unit 524 amplifies the image signal to increase the effective wireless transmission distance. The wireless acquisition circuit 54 includes a RF signal acquisition unit 540, a RF demodulation unit 542, a decoding unit, and a sound amplifier 546. The RF acquisition 540 receives the driving signal transmitted from the display device 40 or the sound input unit 70, and then transmits the driving signal to the RF demodulation unit 542. The RF demodulation unit 542 demodulates and rectifies the driving signal. The decoding unit 544 decodes the encoded driving signal, and then transmits the decoded driving signal to the gas generator 40 for releasing the tear gas. The sound amplifier 546 receives the sound signal transmitted from the sound input unit 70, and transmits the sound signal to the broadcast unit 72 for broadcasting and communication.

The wireless acquisition circuit 56 includes a RF acquisition unit 560, a RF demodulation unit 562, a signal processing unit 564, and a data storage unit 566. The RF acquisition unit 560 receives the image signal transmitted from the wireless radiation unit 52, and then transmits the image signal to the RF demodulation unit 562 for demodulating the image signal. The image signal meanwhile is transmitted to the signal processing unit 564 and stored in the data storage unit 566. The display device 30 accesses the image signal stored in the data storage unit 566, and then displays the image corresponding to the image signal.

The wireless radiation circuit 58 includes a sound amplifier 580, a low-pass filter 582, an encoding unit 584, a resonant frequency generation unit 585, a RF modulation unit 586, and a RF amplification unit 588. The sound amplifier 580 receives a sound and then generates a sound signal. The low-pass filter 582 filters the sound signal, and the decoding unit 584 encodes the sound signal or the driving signal. The RF modulation unit 586 receives the filtered and encoded sound signal or driving signal, and then modulates the sound signal or the driving signal. Furthermore, the modulated sound signal or driving signal transmitted from the RF modulation unit 586 is amplified by the RF amplification unit 588, and then transmitted to the broadcast unit 72 or the gas generator 40.

Furthermore, the micro supervisory system includes a transmission/receiving unit 55 coupled between the wireless acquisition circuit 52 and the wireless radiation circuit 54 and coupled between the wireless acquisition circuit 56 and the wireless radiation circuit 58.

Besides, the sensing module 60 further includes a motor 608 coupled to the control circuit 606. When the detector 600 detects the presence of people, the detector 600 generates a detection signal and then transmits the detection signal to the control circuit 606. The control circuit 606 receives the detection signal and then transmits to the switch 62 for switching the battery 64 on. The control circuit 606 receives the driving signal and then generates a control signal. The motor 608 receives the control signal transmitted from the control circuit 606, and then rotates the upper cover 14 of the casing of the micro supervision system, such that the micro supervision system can easily monitor present situation.

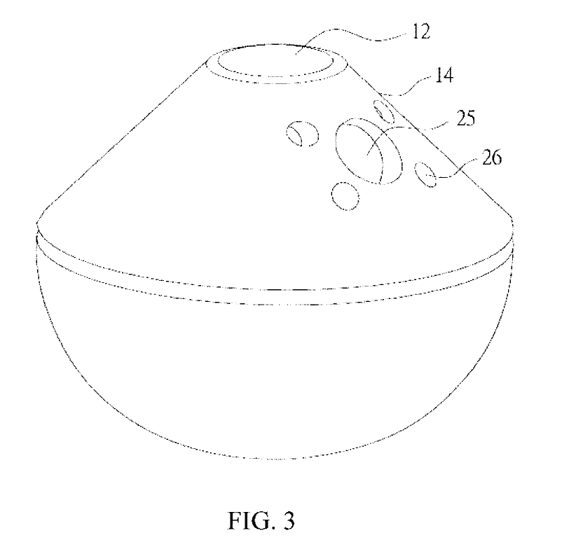

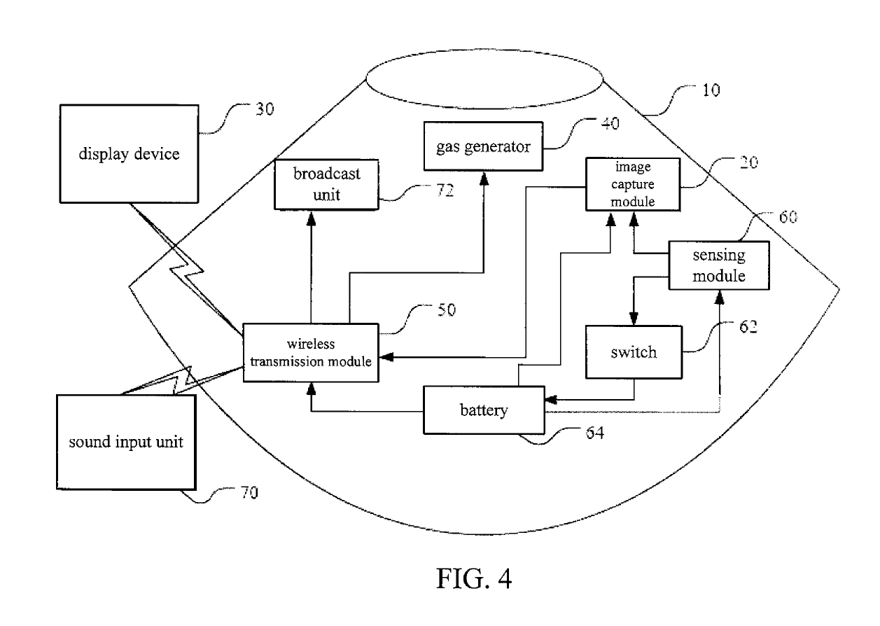

Please refer to FIG. 3 and FIG. 4. FIG. 3 is a schematic diagram illustrating the casing of the micro supervisory system according to a preferred embodiment of the invention. FIG. 4 is a schematic diagram combining main elements of the micro supervisory system shown in FIG. 1 and the casing shown in FIG. 3. The micro supervisory system of the invention includes three parts, respectively disposed in an upper part, a lower part, and a bottom part. The image capture module 20 and the gas generator 40 are disposed in the opening 12 of the upper part of the casing 10. The wireless transmission module 50 is disposed in the lower part of the casing 10, and the battery 80 is disposed n the bottom part of the casing 10. The switch is disposed on the micro supervisory system, and the switch 62 is connected to the battery and used for switching the battery on/off. The light source 26 of the image capture module 20 is disposed around the lens 25. The monitored target which the lens 25 faces to is illuminated with the light radiated from the light source 26. The light reflected from the monitored target passes through the lens 25, so the image sensing element 242 receives the reflected light and then generates the image signal. The image signal is then transmitted to the wireless transmission module.

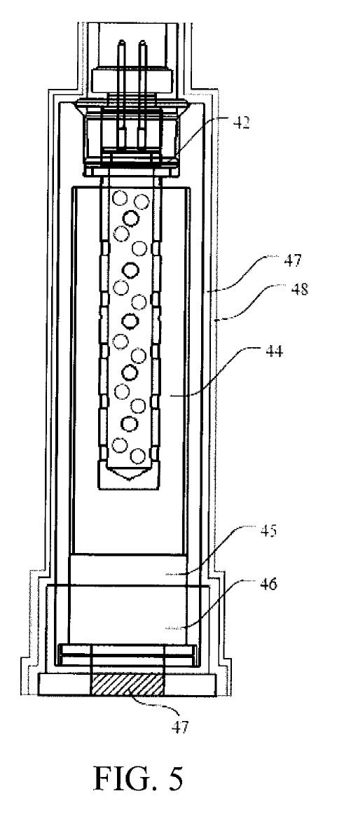

Please refer to FIG. 5. FIG. 5 is a schematic diagram illustrating the gas generator according to a preferred embodiment of the invention. As shown in FIG. 5, the gas generator 40 has a column casing. One end of the column casing is sealed, and the other end of the column casing is covered by an aluminum alloy thin film. The igniter 42, the combustor 44, the enhanced agent pillar, and the filtering chamber 45 are sequentially arranged in the casing and disposed along an axial direction of the casing. The combustor 44 is loaded with mixed gas generation agent (e.g. bromated gas generation agent). The igniter 42 is disposed above the combustor 44, and when the gas generator 40 receives the driving signal, the igniter 42 causes the mixed gas generation agent to burn and then generating high-temperature gas and slag. Alternatively, an anode of the igniter is electrically connected to a cathode, and the igniter generates an arc to ignite the mixed gas generation agent. The high-temperature gas and the slag are filtered by the filtering chamber 46, and then the gas bursts through the aluminum alloy thin film 46. Large amounts of the tear gas or other choking gas is vented from the gas hole 47. The filtering chamber 45 is used for blocking the slag, and prevents the slag from damaging other elements of the supervisory system. Furthermore, the outer casing of the gas generator 40 is coasted with an electronic-wave shielding layer 48 and a high-temperature resistant layer 49.

In this embodiment, the image capture module 20, the sensing module 60, the wireless transmission module 50, and the battery 64 are dismountable modules. Therefore, the image capture module 20, the sensing module 60, the wireless transmission module 50, and the battery 64 are assembled into a micro monitor. The material of the lens 25 of the image capture module 20 is plastic or glass. The illumination angle of the light source 26 can be adjusted, and the maximum illumination angle of the light source 26 is 70 degrees.

The gas generator 40 of the invention and the tumbler-shaped casing are dismountable modules, so the gas generator 40 and the tumbler-shaped casing can be assembled into a micro monitor. The micro supervisory system of the invention can be widely applied to many applications by the aforesaid functions. Besides, the micro supervisory system of the invention is not limited to the transmission wire, and the RF power can be adjusted according to the transmission distance of the RF signal, to be easily disposed on some places for anti-theft or fire-prevention. The volume of the micro supervisory system is small and portable, so it is even used for protection.

In summary, the micro supervisory system of the invention includes a casing, an image capture module, a display device, and a gas generator. The image capture module is disposed in the casing, and captures an image and then generates an image signal. The display device receives the image signal and then generates a driving signal. The gas generator is disposed in the casing, and receives the driving signal and then generates a gas for anti-riot scenarios. The tear gas is released from the gas generator and is used for expelling people. Therefore, the micro supervisory system of the invention can be applied to military spies, anti-riot supervision, and calamity supervision.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A micro supervisory system, comprising:
a casing;
an image capture module, disposed in the casing, for capturing an image and then generating an image signal;
a display device, receiving the image signal and then generating an driving signal;
an gas generator, disposed in the casing, receiving the driving signal and then generating a gas; and
a wireless transmission module, receiving the image signal and then transmitting the image signal to the display device for monitoring, and meanwhile receiving the driving signal and then transmitting the driving signal to the gas generator.

2. The micro supervisory system of claim 1, further comprising:
a sensing module, disposed in the casing, for sensing an object and then generating a sensing signal; and
a switch, receiving the sensing signal and then switching on a battery for providing the image capture module and the wireless transmission module with a power.

3. The micro supervisory system of claim 2, wherein the sensing module comprises:
at least one detector, for detecting the object and then generating a detecting signal; and
a control circuit, receiving the detecting signal and then generating the sensing signal.

4. The micro supervisory system of claim 3, wherein the sensing module comprises a multiplexer, coupled between the at least one detector and the control circuit.

5. The micro supervisory system of claim 3, wherein the sensing module comprises a motor, receiving a control signal of the control circuit and then moving the micro supervisory system.

6. The micro supervisory system of claim 3, wherein the sensing module is an infrared sensor or a thermal sensor.

7. The micro supervisory system of claim 2, wherein the image capture module comprises:
a light control unit, receiving the power and the sensing signal and adjusting a brightness of a light source according to an environment brightness; and
an image sensing module, generating the image signal based on the image captured by a lens and according to the brightness of the light source.

8. The micro supervisory system of claim 7, wherein the image sensing module comprises:
an exposure gain control component, for adjusting a light received by the lens according to the environment light; and
an image sensing component, generating the image signal based on the image captured by the lens and according to the light adjusted by the exposure gain control component.

9. The micro supervisory system of claim 7, wherein the lens is a non-spherical pantoscope with single lens, a non-spherical pantoscope with two lenses, or a liquid zoom lens.

10. The micro supervisory system of claim 1, further comprising:
a sound input unit, for receiving a sound and then generating a sound signal, the sound signal being transmitted by the wireless transmission module; and
a broadcast unit, receiving the transmitted sound signal and then broadcasting the sound according to the sound signal.

11. The micro supervisory system of claim 1, wherein the casing is in a shape of a tumbler.

12. The micro supervisory system of claim 11, wherein the tumbler-shaped casing is used for keeping the image capture module capturing the image at an angle of 45 degrees.

13. The micro supervisory system of claim 11, wherein a material for the casing is a shock-proof material.

14. The micro supervisory system of claim 1, wherein the gas generator and the casing are dismountable modules.

15. The micro supervisory system of claim 1, wherein the wireless transmission module comprises:
a wireless radiation circuit, receiving and then radiating the image signal or the driving signal; and
a wireless acquisition circuit, receiving and then transmitting the image signal or the driving signal to the display device and the gas generator.

16. The micro supervisory system of claim 15, wherein the wireless radiation circuit comprises:
a radio frequency modulation unit, for modulating the image signal or the driving signal and then generating a modulated signal;
a radio frequency amplification unit, for amplifying the modulated signal; and
a radio frequency radiation unit, for transmitting the modulated signal to the display device or the gas generator.

17. The micro supervisory system of claim 15, wherein the wireless acquisition circuit comprises:
a radio frequency acquisition unit, for acquiring and then outputting the image signal or the driving signal; and
a radio frequency demodulation unit, for demodulating and then transmitting the image signal or the driving signal to the display device and the gas generator.

18. The micro supervisory system of claim 1, wherein the gas generator comprises:
a trunk casing; and
a combustor, disposed in the trunk casing and loaded with a mixed gas generation agent, an igniter being disposed above the combustor, when the gas generator receives the driving signal, the igniter ignite the mixed gas generation agent to generate the gas with high-temperature.

19. The micro supervisory system of claim 18, wherein the gas generator comprises a cooling filter chamber, disposed in the trunk casing and below the combustor.

20. The micro supervisory system of claim 18, wherein an outer surface of the trunk casing is coated with a high-temperature resistant layer and an electronic-wave shielding layer.
